(19) United States
(12) Patent Application Publication
(10) Pub. No.: US 2006/0111973 A1
(43) Pub. Date: May 25, 2006

(54) Stored value mileage card systems and methods of use

(75) Inventors: Jaime Paul Brown, Denver, CO (US); Ken Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/997,771

(22) Filed: Nov. 23, 2004

(51) Int. Cl. G06Q 30/00

(52) U.S. Cl. 705/14

(57) ABSTRACT

Systems and methods for managing mileage value accounts are provided. One such method includes receiving a presentation instrument having an account identifier stored thereon, and transmitting the account identifier and a purchase item identifier from a point-of-sale device to a host computer system. Using the host computer system, a customer account is identified based on the account identifier. A mileage value is associated to the purchase item identifier. The customer account is debited by the mileage value associated to the purchase item identifier. In this manner, the customer uses their mileage value account for the purchase of desired items or services. For airline travelers, the items may include a meal, a beverage, or a movie.

### CROSS-REFERENCES TO RELATED APPLICATIONS

This application is related to the following pending U.S. patent applications, assigned to the assignee of the present invention, with the complete disclosures of each incorporated herein by reference for all purposes.

1) U.S. patent application Ser. No. 9/971,303, filed Oct. 3, 2001, entitled Stored Value Cards and Methods for Their Issuance;

2) U.S. patent application Ser. No. 10/421,604, filed Apr. 22, 2003, entitled Multi-Purse Card Systems and Methods;

3) U.S. patent application Ser. No. 10/740,378, filed Dec. 17, 2003, entitled Systems and Methods for Integrating Loyalty and Stored-Value Programs; and

4) U.S. patent application Ser. No. 10/744,888, filed Dec. 23, 2003, entitled Stored Value Lottery Card and Methods.

### BACKGROUND OF THE INVENTION

Beginning in about 1981 with the American Airlines AAdvantage Program, U.S. based airlines have offered benefits to their frequent passengers. Nowadays, most airlines have rewards programs that allow passengers to accrue “frequent flier” miles based on a number of factors. Originally, passengers earned one frequent flier mile for every actual mile traveled on that airline. As a result, passengers who traveled frequently earned miles in their account more quickly than infrequent travelers. Once certain mileage levels were obtained in the passenger's account, the passenger could redeem those miles for free airline tickets, free upgrades from coach to business or first class, or the like. Many airlines also have allowed their most frequent travelers to distinguish themselves within the frequent flyer programs by obtaining gold, platinum, or some other elevated status of frequent flyer. By obtaining such status, the frequent flyers often can more easily accrue miles, receive free upgrades to first class, have expedited boarding procedures, and the like.

While the original programs rewarded passengers based on actual miles flown, the airlines eventually partnered with other companies in a manner which allows passengers to accrue mileage more easily. For example, some airlines partnered with hotel and rental car companies. A traveler arriving in their destination city could accrue miles in their airline frequent flier account by renting cars from designated rental companies or by staying in hotels partnered with the airline they used to arrive at their destination.

Over time, the number of ways a passenger could accrue miles expanded beyond the travel industry as companies in other industries formed partnerships with the airlines. For example, customers using a designated telephone service provider may accrue miles in an amount related to their monthly long distance telephone charges. Similarly, a number of banking institutions provide credit cards which are associated with an airline. When the card is used to make purchases, the card holder receives a specified number of frequent flier miles for each dollar charged to the card. In many cases, customers can accrue a great many more miles through these affiliated programs than they do through actual miles traveled by plane.

It would be fair to say that since 1981, airlines have greatly expanded the number of ways a customer can accrue miles. Unfortunately, the ways those miles can be used, and the ease at which they can be redeemed has not grown as fast. Customers can redeem 25,000 miles, 30,000 miles, or more for free airline tickets on the airline associated with the frequent flyer program. However, the airline typically imposes “blackout” days, or days on which the miles cannot be used for travel. These blackout days often fall on and around common travel holidays such as Christmas, Thanksgiving, and the like. Further, for most flights only a handful of seats can be “purchased” using redeemed miles. Customers wanting to travel to popular vacation spots such as Hawaii may have to plan many months in advance in order to reserve a seat using redeemed miles. While some programs allow miles to be redeemed for cash (e.g., at the rate of 2 cents per mile), there may be limitations on how this occurs as well. For example, the customer may be required to have a particular type of credit card to cash in their miles for money.

An airline which provides its customers with additional uses for their miles and makes the miles easier to cash in could have a competitive advantage.

### BRIEF SUMMARY OF THE INVENTION

The present invention provides methods and systems for managing mileage value accounts. In one embodiment, a method includes receiving a presentation instrument having an account identifier stored thereon, and transmitting the account identifier and a purchase item identifier from a point-of-sale device to a host computer system. The method includes identifying, using the host computer system, a customer account based on the account identifier. A mileage value is associated to the purchase item identifier. The customer account is debited by the mileage value associated to the purchase item identifier. In this manner, the customer uses their mileage value account for the purchase of desired items or services. In some aspects, the item identifier identifies an item to be purchased by a customer associated with the customer account. The items may include a meal, a beverage, a movie, a seat upgrade, and the like. The item also may be an item selected from a catalog, or otherwise available for purchase while traveling by airplane, train, bus or the like.

In some embodiments, the presentation instrument is a boarding pass. In this manner, passengers and others on an airplane, train or other means of travel, can use frequent travel miles for the purchase of desired items and/or services. The account identifier is stored on the presentation instrument using a magnetic stripe in one aspect, although it also may be printed on the instrument, stored in a bar code on the instrument or the like. The account identifier itself may be a frequent flyer account number, a credit card number, a loyalty account number, or the like.

In some aspects, a confirmation is provided to a customer associated with the customer account. The confirmation may be provided by printing a receipt at the point-of-sale device after reading the account identifier from the presentation instrument. In other aspects, customer account statements are sent to the customer periodically, such as monthly, quarterly, annually, or the like.

Additionally, the present invention provides methods for processing transactions using mileage value accounts. One such method includes a point-of-sale device receiving a mileage summary for a plurality of customers. This may involve, for example, a flight attendant receiving the mileage summary with a point-of-sale device before or after boarding a commercial airline flight. The method further includes receiving a presentation instrument and a purchase request from a first customer, with the presentation instrument having an account identifier stored thereon. The method involves identifying a mileage value associated with a subject of the purchase request, comparing the mileage value with the mileage summary for the first customer, and providing the first customer with the subject of the purchase request if the mileage value is equal to or less than an available mileage in the first customer's mileage summary.

In some aspects, a debit record associated with the purchase request is created and transmitted to a host computer system. In this manner, the customer account may be debited the proper number of miles. In some cases, the debit record includes the account identifier and the mileage value associated with the subject of the purchase request. The mileage summary, in one aspect, includes a list of available miles for at least some of the customers having a mileage value account. For example, some customers on the airplane likely will not have a mileage value account at all, or will not have one associated with that particular airline. In this case, those passengers will not be included in the mileage summary, or will be shown as having zero (0) miles, identified as a non-account holder, or the like. In other embodiments, the ability to use miles for the purchase of items during travel may be limited to a particular class of travelers, or only for travelers having attended a certain status or level within the mileage value account system. In this manner, the mileage account summary may not have information on all customers or passengers on the aircraft, train, or the like.

In one aspect, identifying the mileage value further includes identifying the mileage value associated with both the subject of the purchase request and the account identifier. In this manner, customers having premier, executive, gold, platinum, or some other elevated status can be charged a different mileage amount for the purchased item. In this manner, if desired the airline can reward its most frequent travelers.

The present invention includes computerized mileage value account systems. In one embodiment, the system includes a plurality of presentation instruments that each have a unique account identifier, and a host computer system having a processor coupled to a database. The host computer system is configured to receive an account identifier and a purchase item identifier, identify a customer account based on the account identifier, associate a mileage value to the purchase item identifier, and debit the customer account by the mileage value associated to the purchase item identifier.

In some aspects, the host computer system is further configured to receive the account identifier and the purchase item identifier from a point-of-sale device, and to return an authorization to the point-of-sale device if an account associated with the account identifier has a mileage level greater than or equal to the mileage value associated with the purchase item identifier.

In some embodiments, the host computer system database may contain a record of the account identifiers, and/or may include the purchase item identifiers and their associated mileage values. In other embodiments, the host computer system is coupled to a second database having a record of the account identifiers stored therein. The second database may be coupled to an airline host computer system, in one aspect, and may further include a plurality of purchase item identifiers and a plurality of mileage values associated therewith.

The present invention further provides systems and methods by which one or more customers can bid on a good or service. The good or service, in some aspects, is a seat upgrade, a free travel coupon, a meal, a movie, or the like, for travel by airplane, bus, motor coach, cruise ship, train, and the like. In a particular embodiment, a method for processing transactions using mileage value accounts includes the offering of a good or service to a plurality of customers. The method includes receiving a bid from at least one of the customers, with the bid comprising a mileage amount. Received bids are compared and a winning bidder is selected from the plurality of customers. The good or service is provided to the winning bidder. The method includes creating a debit record including the mileage amount of the winning bid, and associating the debit record with a mileage account of the winning bidder. In this manner, customers can bid on a good or service, and redeem miles to pay for it.

In one aspect, the debit record is created using a point-of-sale device. In another aspect, the received bids are compared to mileage summaries for the associated bidders to confirm that the summary has sufficient miles for the customer's bid. This may include confirming that the mileage summary is equal to or greater than the received mileage bid amount. In still another aspect, the method includes transmitting the debit record to a computer system that is adapted to update the mileage account of the winning bidder.

Other objects, features and advantages of the present invention will become more fully apparent from the following detailed description, the appended claims and the accompanying drawings.

### BRIEF DESCRIPTION OF THE DRAWINGS

FIG. 1 is a schematic diagram of a system for managing mileage value accounts according to an embodiment of the present invention;

FIGS. 2A and 2B are front and rear views, respectively, of a presentation instrument that may be used with the invention;

FIGS. 3A and 3B are front and rear views, respectively, of another presentation instrument that may be used with the invention;

FIG. 4 is a schematic view of a diagram of a point-of-sale device that may be used in accordance with the present invention; and

FIG. 5 is a flow chart illustrating one method of processing transactions using mileage value accounts according to the present invention.

### DESCRIPTION OF THE SPECIFIC EMBODIMENTS

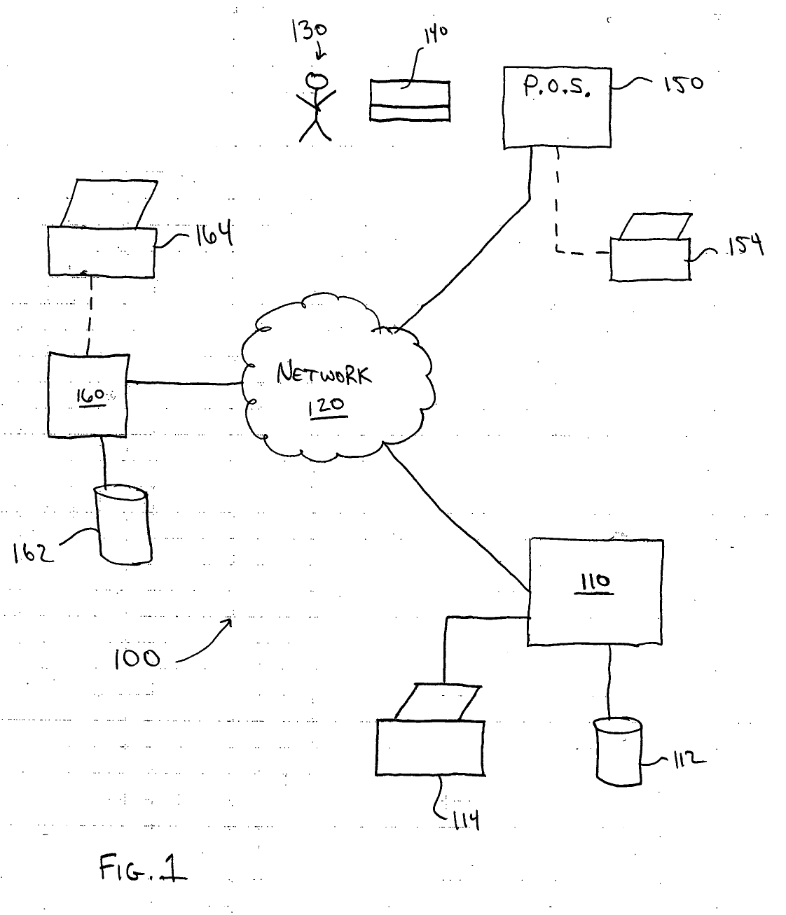

Referring now to FIG. 1, one embodiment of an account management system 100 according to the present invention will be described. System 100 includes a host computer 110 coupled to a database 112. Host computer 110 and database 112 store a wide variety of information related to mileage value accounts and their management. In one embodiment, host computer 110 maintains a plurality of account identifiers associated with customer accounts. As accounts are activated, created, and/or downloaded, host computer 110 and database 112 are employed to perform functions in a manner similar to those described in U.S. Application No. 60/392,958, filed Jun. 28, 2002, U.S. application Ser. No. 10/268,040, filed Oct. 8, 2002, U.S. application Ser. No. 10/267,180, filed Oct. 8, 2002, U.S. application Ser. No. 10/286,006, filed Nov. 1, 2002, U.S. application Ser. No. 10/356,207, filed Jan. 30, 2003, U.S. application Ser. No. 10/371,167, filed Feb. 21, 2003, the complete disclosures of which are herein incorporated by reference. As such, host computer 110 may include appropriate hardware and software in addition to database 112 for these functions. Host computer 110 may also include appropriate inputs and outputs for receiving and transmitting information in electronic form.

For example, information may be received by host computer 110 from a point-of-sale device 150. Host computer 110 also may receive information from voice response units, server computers, personal computers, wireless devices, and the like. Similarly, outputs may be transmitted to any device capable of receiving electronic documents. Information may be transmitted to and from host computer 110 through a variety of networks, schematically depicted as a network 120. Network 120 may include telephone networks, credit card networks, wide area networks, the Internet, wireless networks, and the like. Further, depending on the type of processing device used to transmit the information, such devices may also be coupled to a financial network such as a credit card network or ATM network, or may have a direct connection to other host computer systems. If connected to a financial network, host computer 110 may be configured to determine that the transaction is related to a mileage value account rather than a traditional credit account. Host computer 110 may further be coupled to a printer 114. In one embodiment, printer 114 is used to print confirmation slips or receipts reflective of particular transactions processed by host computer 110. In other embodiments, printer 114 is used to print customer statements summarizing the customer mileage value accounts for mailing to the customers. Receipts and statements also may be transmitted using electronic transmission, wireless transmission, or the like.

In one embodiment, host computer 110 is coupled via network 120 to an airline computer system 160. Airline computer system 160 may include a wide range of hardware and software components including, for example, user stations or terminals, processors, servers, memory, and the like. In one embodiment, airline computer system 160 includes a database 162 for storing information relevant to the airline operation. In one embodiment, database 162 is used to store frequent traveler account information. Airline computer system 160 is coupled to one or more printers 164 for printing desired documentation. This documentation may include without limitation, receipts, boarding passes, tickets, special offers, reports, receipts, account statements and the like.

System 100 further includes a point-of-sale device 150 that may be optionally coupled to a printer 154. Point-of-sale device 150 is used to receive a presentation instrument 140 from a user 130. Presentation instruments 140 and point-of-sale device 150 will be described in greater detail in conjunction with subsequent figures.

In some embodiments, mileage value account system 100 will be particularly useful for other transportation or related companies having frequent traveler, frequent user, or customer reward programs. While the below example involves the airline industry, computer system 160 may be used by a wide range of companies, including rental car companies, and companies providing travel by train, bus, airline, cruise line, or the like. Organizations in the hotel industries also may use computer system 160. Thus, the present invention is not limited by the specific examples detailed herein.

In one embodiment, user 130 is an airline passenger having a mileage value account, also referred to as a frequent flyer account. This user account is associated with a particular airline (e.g., United, Frontier, Southwest) operating computer system 160. User 130 has accrued a number of miles in their frequent flyer account. Details pertinent to the frequent flier account, including the account identifier or account number and the accrued mileage level, are maintained in database 162. In another embodiment, the account identifiers and mileage associated therewith are maintained in database 112. In this particular example, user 130 has boarded an aircraft for a domestic or international flight and wants to purchase a meal, a beverage, and/or view the in-flight movie. Since user 130 is unfortunate enough to be riding in the coach section of the plane, these goods and services must be paid for by user 130. In a particular embodiment of the present invention, system 100 allows user 130 to pay for these goods and services using miles maintained in user 130's mileage value account.

In one embodiment user 130 redeems miles from their mileage value account to pay for the meal, beverage, in-flight movie, and other desired goods and services available on the airplane. For example, if the airline is charging $6.00 for the in-flight meal, in one embodiment the user redeems three hundred (300) miles to pay for the meal. In this example, each mile is valued at two cents ($0.02). Similarly, if the airline is charging $5.00 for the in-flight movie, the user redeems (250) miles to purchase the right to view this movie. In this manner, user 130 is able to eat the airline meal and view the in-flight movie without having to use currency, a credit card, or the like. Instead, user 130 pays for these goods and services with mileage accrued through prior travel on that airline, or obtained by any number of other ways as known to those skilled in the art. System 100 facilitates the redemption of customer miles from a mileage value account through the interaction of point-of-sale device 150, host computer 110, and network 120. Further, the transaction also may involve airline computer system 160 in some embodiments.

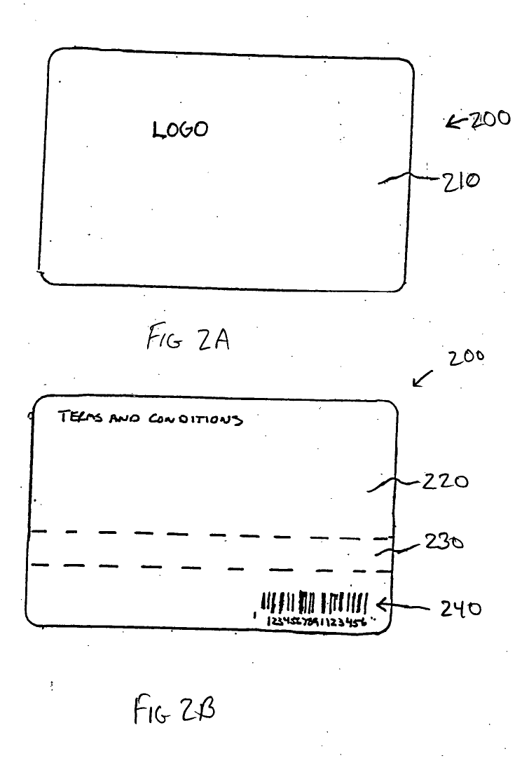

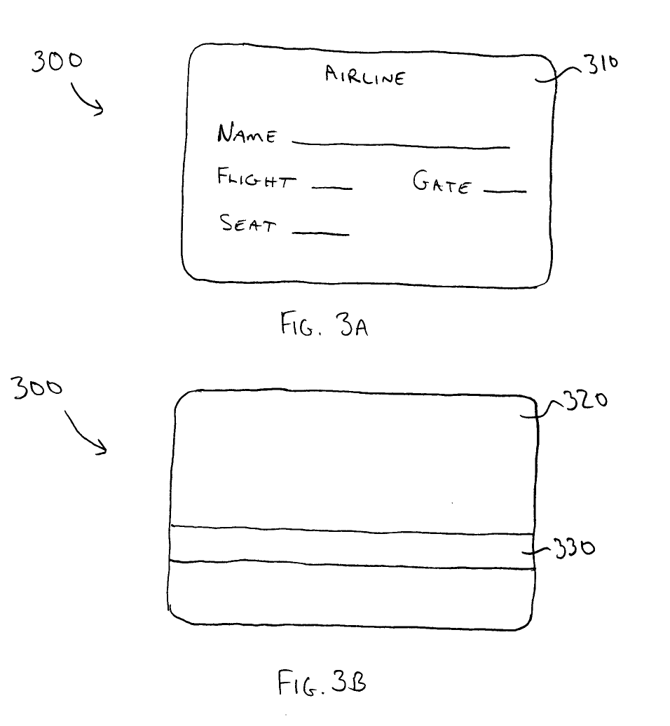

In a method of the present invention, user 130 presents presentation instrument 140 to the gate attendant or the flight attendant. In some embodiments, presentation instrument 140 will comprise a credit card, debit card, or the like. In other embodiments, presentation instrument 140 is a boarding pass. Further details on the presentation instruments 140 are described in conjunction with FIGS. 2A-2B and 3A-3B. In one embodiment, the gate attendant or other airline employee working the boarding gate receives presentation instrument 140 and enters the user account identifier into computer system 160 and/or point-of-sale device 150. The user account identifier may be a credit card number, a mileage value account number, or the like. The gate attendant also may look up the appropriate account identifier upon receipt of user 130's name, address, or other personal information. In one embodiment user 130's mileage account is tied to one or more credit cards. In this manner, user 130 can provide the gate or flight attendant their credit card number, and the attendant can identify user 130's mileage account using, for example, point-of-sale device 150 or computer system 160.

User 130 identifies the item they wish to purchase with miles (e.g., in-flight movie, meal, beverage, etc.). The gate attendant creates a debit record, so user 130's account can be debited the required number of miles associated with the purchased item. In some embodiments, user 130 receives a receipt showing they have redeemed miles for a purchase item. User 130 then can present the receipt to the flight attendant before or during flight, to receive the purchased item. In other embodiments, user 130's boarding pass is printed or reprinted to include the receipt. In one embodiment, point-of-sale device 150 receives an update from system 160 prior to or after departure of the aircraft. The update identifies user 130 as having a credit for the purchased item. Alternatively, the flight attendant receives a written printout identifying user 130 as a paying customer for the desired item. Other methods exist for conveying to the aircraft or flight attendant that user 130 has paid for a particular item with redeemed miles.

In a particular embodiment, passenger 130 is on an airplane in flight when they decide to use miles associated with their mileage value account to pay to view the in-flight movie. In this embodiment, user 130 presents presentation instrument 140 to the flight attendant, who swipes the presentation instrument in or through point-of-sale device 150. Alternatively or in addition, relevant information from presentation instrument 140 or provided by passenger 130 is entered or keyed into point-of-sale device 150. When the flight attendant enters the presentation instrument 140 information into point-of-sale device 150, an account identifier corresponding to user 130 is received. In a particular embodiment, point-of-sale device 150 maintains a record of which presentation instrument 140 it has scanned or otherwise received data from. The flight attendant also may enter the purchase item identifier associated with the user-requested item (movie, meal, etc.). In some embodiments, printer 154 is used to print a receipt for the purchased item or service, which can be provided to user 130.

Once the airplane has landed, or once point-of-sale device 150 is able to communicate with host computer 110 and/or network 120 and/or airline computer system 160, the request to purchase a particular item is transferred to host computer 110 for account reconciliation. The information transferred to computer 110 may include an account identifier, a user or account name, a purchase item identifier, a mileage value associated with the purchase item identifier, and the like. The purchase item identifier, for example, may comprise a code or other designator for the movie, meal, beverage, or the like. In one embodiment, goods and services are provided to user 130 based on an assumption that user 130 has sufficient miles in their mileage value account to pay for those goods and services.

In another embodiment, the purchase item identifier is transferred to host computer 110. Host computer 110 associates the purchase item identifier with a mileage value. For example, in one embodiment the airline has a mileage schedule, applicable for all passengers riding in the coach section, which shows the mileage cost of the meal, movie, or the like. In this embodiment, host computer 110 associates a certain number of miles (e.g., 300 miles) to user 130's request to purchase a meal, movie, or the like. It will be appreciated by those skilled in the art that the particular miles or charges for various items may vary within the scope of the present invention. Once the association is made between the purchase item identifier and the mileage value, the mileage is deducted from user 130's account maintained within host computer 110 and/or within airline computer 160. As previously noted, account statements may be periodically transmitted to the user by printing on printer 114 and mailing the statements to user 130. Alternatively, electronic statements may be sent to a user email address, or available to the user on a password protected website. In this manner, user 130 is able to use miles to pay for the desired item(s).

Referring now to FIGS. 2A and 2B, one embodiment of presentation instrument 140 for use with the invention will be described. In general, presentation instruments 140 of the present invention may be constructed of a wide variety of materials that are capable of storing an identifier that uniquely identifies the associated account. For example, presentation instrument 140 may comprise a card 200 (that in turn may be constructed of plastic, cardstock, paper, or the like). Other materials include a computer disk (such as a CD, DVD or the like) or other tangible media. Card 200 has a first surface 210 and a second surface 220. In some embodiments first surface 210 is a front surface, while in other embodiments first surface 210 is a back surface of card 200. Similarly, second surface 220 may be a front or back surface in alternative embodiments.

An account identifier is stored on card 200 in at least one of a number of different formats. In some embodiments, the account identifier is printed on one or both surfaces 210 and 220. In other embodiments the account identifier is embossed in card 200 to create a raised portion thereof. Such a technique is commonly used for credit cards. In still other embodiments, the account identifier is disposed in magnetic media (such as a magnetic stripe 230), in a bar code format 240, in a computer processor (also known as a smart chip) or the like. Card 200 may also include issuer or customer identification information, such as a name, a logo, terms and conditions, or the like; an expiration date; counterfeit protection measures such as a hologram; and a number of other features.

In another embodiment, presentation instrument 140 is a boarding pass 300 as shown in FIGS. 3A-3B. In a particular embodiment boarding pass 300 includes a first surface 310 and a second surface 320. Again, first and second surfaces 310, 320 may be the front or back surface of boarding pass 300. Boarding pass 300 has information printed thereon, such as a passenger name, flight number, gate number, seat assignment, airline name, and the like. Second surface 320 has a magnetic stripe or magstripe 330 coupled thereto. As shown in FIG. 3B, magstripe 330 is bonded to surface 320, which in one embodiment is the back of boarding pass 300. Desired information is recorded on magstripe 330. In some embodiments, magstripe 330 stores the passenger flight information, including a flight number, a seat number, a passenger name, a tag number, or the like.

Passengers receive boarding passes 300, advance to the boarding gate to the plane and insert boarding passes 300 into the reader installed at the boarding gate. The reader reads the flight information from each boarding pass 300 to confirm that the boarding pass is effective. In some embodiments, reading of boarding pass 300 also provides the airline with a confirmed passenger manifest. In this manner, the airlines can help ensure that passengers who checked baggage get on the same plane as their bags.

As noted above, in some embodiments the presentation instrument 200, 300 includes a magnetic stripe for containing at least some desired information. More specifically, presentation instrument 200 may be a standard magnetic card or a mini-card as commonly used in the United Kingdom, Europe, and the United States, which may conform to the appropriate ISO/IEC standard. Boarding pass 300 also, in some embodiments, includes a magnetic stripe. For these presentation instruments 200, 300, magstripe 230, 330 is comprised of a large number of tiny iron-based magnetic particles disposed in a plastic-like film. Each particle can be magnetized in either a north or south pole direction to maintain desired information. The information is laid down in magstripe 230, 330 in two or more tracks, such as tracks governed by ISO/IEC Standard 7811. Generally, a wide variety of information may be stored in the magnetic strip, and the issuer of the presentation instrument has the option of deciding at least some of the information contained therein. For example, magstripe 230, 330 may contain a merchant identification, a customer identification, a card or account identifier, an expiration date, a credit card limit if the presentation instrument is a credit card, usage records, a password or personal identification number (PIN), mileage value account summaries, and the like. In this manner, presentation instruments 200, 300 having magnetic strips can be fashioned to contain desired information in accordance with the present invention. As previously noted, in other embodiments the presentation instrument is a smart card that provides numerous benefits including increased cryptography aspects for security purposes. Smart cards may contain additional information beyond that maintained in a magnetic stripe including, if desired, mileage updates for a frequent traveler program.

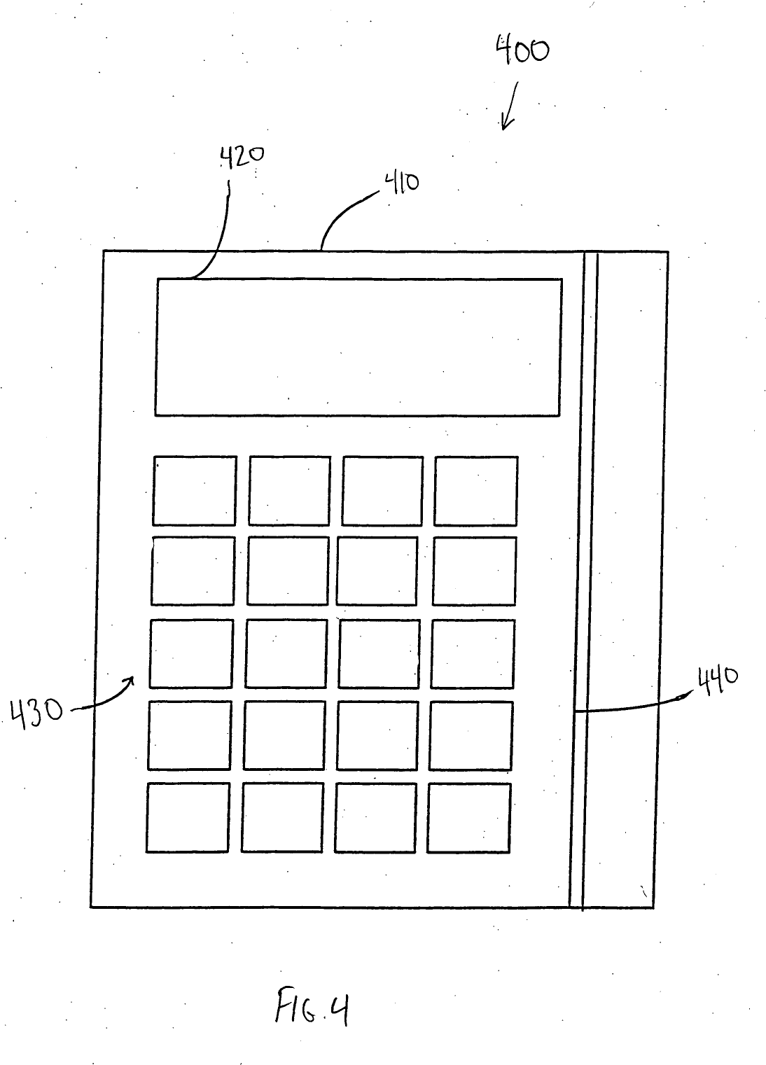

Referring now to FIG. 4, a point-of-sale device 400 that may correspond to point-of-sale device 150 will be described in greater detail. In so doing, it will be appreciated that the invention is not intended to be limited for use with only a specific type of point-of-sale device. For example, point-of-sale devices that may be used to capture and/or transmit such information to a host computer system are described in copending U.S. application Ser. No. 10/116,619, filed Apr. 3, 2002, the complete disclosure which is herein incorporated by reference. Other ways of transmitting information include by telephone (such as by using an IVR system), mobile or wireless devices, by contacting a customer service representative or the like. Indeed, any type of processing or computing device that may transmit and receive data over a network may be used.

In one embodiment, point-of-sale device 400 comprises a housing 410 having a display screen 420 and input devices 430. Conveniently, input devices 430 may comprise keys or buttons that may be depressed to enter information into the point-of-sale device 400. Input devices 430 also may be portions of a touch screen. Input devices 430 may each be associated with one or more letters or other alpha numeric characters, or may operate as function keys. In one embodiment, point-of-sale device includes a groove 440 disposed therein for receiving presentation instruments. Groove 440 may be positioned and configured on device 400 to receive the presentation instrument as it is swiped through groove 440. Point-of-sale device 400 receives the account identifier from the presentation instrument, and receives a purchase item identifier from input devices 430. In one embodiment, device 400 includes a mileage schedule so device 400 is able to associate miles to the purchase item identifier. In some embodiments device 400 creates a debit for user 130 account, and in other embodiments device 400 stores the debit record for subsequent transmission to host computer 110 and/or airline computer system 160. Some or all of this information may be shown on display 420, and may optionally be printed to provide a paper receipt.

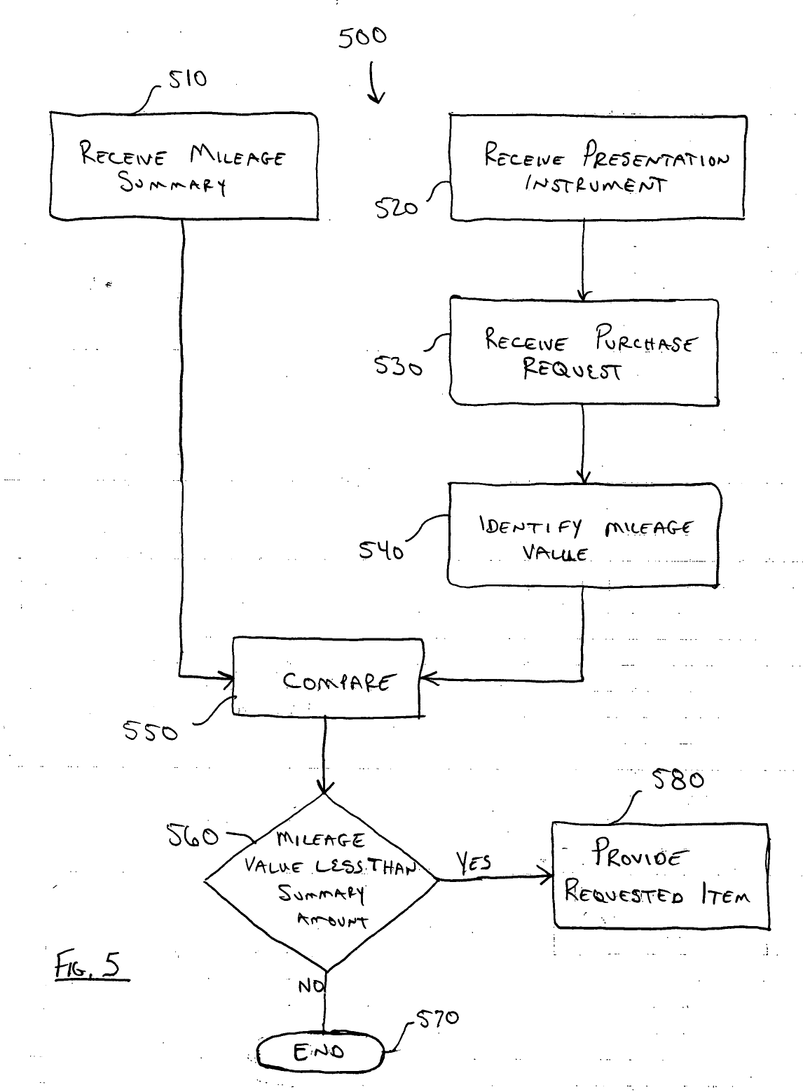

Turning now to FIG. 5, a method 500 of the present invention will be described. Method 500 includes the receipt of a mileage summary (Block 510). In one embodiment, this involves a gate attendant or flight attendant receiving a summary of the mileage value accounts for passengers traveling on a particular flight. In another embodiment, this involves point-of-sale device 150 being uploaded with a mileage summary, so that flight attendants or others on the aircraft can have access to the mileage summaries for the various passengers traveling on that flight.

In a particular embodiment, method 500 includes receiving a presentation instrument (Block 520) from a passenger, and also receiving a purchase request (Block 530) from the passenger. While FIG. 5 depicts receipt of the presentation instrument and purchase request in order, the invention is not so limited. For example, the customer may provide a purchase request first and then present the presentation instrument to the flight attendant, or may provide both at the same time. The purchase request may be an oral request, a written request, or some other request type. Method 500 further includes identifying a mileage value associated with the purchase request (Block 540). In one embodiment, this includes inserting presentation instrument 140 into point-of-sale device 150 and entering or keying in the purchase item identifier reflective of the purchase request. For example, the flight attendant may enter a particular code or combination of alpha-numeric characters into point-of-sale device 150 to indicate the passenger wants to purchase the right to view the in-flight movie. Identifying the mileage value associated with that request involves, in one embodiment, point-of-sale device 150 referencing a look-up table to determine the mileage value associated with the purchase request, in this case the viewing of the movie. In some embodiments, the mileage value may vary depending on the particular customer. For example, if the particular customer is a frequent traveler having a heightened status within the airline's frequent traveler program, the mileage value associated with the particular purchase request may vary from a similar request received from a new participant of the frequent flyer program. For example, frequent travelers having attained the “Gold” or some other elevated level within the frequent traveler program may be charged a reduced number of miles to view the in-flight movie compared to someone who has not obtained the Gold level. Alternatively, new participants of the program may be charged a reduced rate as an enticement to continue to fly that airline and accrue miles. Other options also are available within the scope of the present invention.

In the embodiment shown in FIG. 5, the mileage value is compared to the mileage summary (Block 550) for the customer requesting the purchased item. More specifically, the mileage summary received in Block 510 contains the mileage level obtained by at least some of the passengers traveling on a particular flight. This mileage summary is compared to the mileage value for the requested item to determine whether the passenger has accrued enough miles to redeem those miles for the desired item. In some embodiments, the mileage summary may have more than one mileage value for each particular customer. For example, the airline may want to allow passengers to redeem miles from only a portion of their mileage value account to purchase meals, movies, or the like. If the mileage summary amount for the particular passenger does not equal or exceed the mileage value for the requested item, the passenger may be denied the right to redeem miles for that desired item (Block 570). In an alternative embodiment, the passenger may use their credit card, cash, or the like to purchase the requested item in its entirety, or to make up any shortfall in miles based on a set monetary value assigned to the miles or the requested item. More typically, the mileage summary for the particular customer is equal to or exceeds that needed to purchase the requested item and approval is given. In this case, the requested item is provided to the customer (Block 580).

In one embodiment, point-of-sale device 150 records a debit for the customer based on the mileage value associated with the approved purchase request. For example, if the customer had many thousands of miles in their account and has requested the use of miles to purchase a meal having an associated mileage value of 500 miles, a debit record is created so that the customer's account is debited 500 miles. In one embodiment, point-of-sale device 150 is used to immediately update the mileage summary for that customer. In some embodiments, this updated mileage summary is transmitted to host computer 110 and/or airline computer system 160 for updating the records stored therein. An another embodiment, a receipt is provided to the customer in flight so that the customer has a record that they used miles to purchase an item. In the event the presentation instrument is a smart card, the card itself may be updated so that the smart card record of the customer's mileage value account is consistent with that maintained by the airline system 160 and/or host computer 110.

In an alternative embodiment, the passenger has perused the in-flight shopping mall magazine and located one or more items they desire to purchase. In some embodiments, a method similar to that described in conjunction with FIG. 5 is used to allow a passenger having a mileage value account to purchase an item from the catalog. In this particular embodiment, a record is maintained of the purchase request and the mileage associated therewith. The purchase request and debit record for the miles redeemed to purchase the item are transmitted to airline system 160 and/or host computer 110 at an appropriate time including, in flight, or post flight. In this manner, the catalog item can be mailed or shipped to the passenger at their address of record on file with their mileage value account. Alternatively, the point-of-sale device may be used by the customer or flight attendant to identify an alternative address to which the purchased item will be shipped. In some cases, the item can be immediately provided to the customer.

In some embodiments, the presentation instrument is a credit card, but the customer wants to redeem miles from a mileage value account to make the above purchase(s). In this case, the credit card is scanned by point-of-sale device 150 as described above. The airline computer 160 and/or device 150 associates a credit card number with the appropriate mileage value account. In this manner, the credit card is used to identify the passenger and locate the mileage value account number, but miles are redeemed to pay for the purchased item. The association between the passenger's credit card number and the mileage value account may occur remotely, such as during a flight, or prior to departure, using point-of-sale device 150 and/or computer system 160.

In some embodiments, passengers 130 may use miles in their mileage value accounts to bid for goods or services using an auction style format. The auction may occur prior to departure of the airplane, train, or the like. Alternatively, the auction may occur at least partially during travel. In one embodiment, an upgraded seat class has not checked in full. Therefore, additional first class, business class, or other upgraded class seats are available for use by the passengers. In one embodiment, the upgraded seat is auctioned to the passengers, with the passengers submitting bids in the form of miles. In one embodiment, the winning bidder is the customer 130 who offers to redeem or “bids” the most miles for the upgraded seat. Once the winning bidder is identified or determined, a debit record is created and associated with the mileage value account for the winning bidder. The debit record corresponds to the number of miles bid, in one embodiment. The debit record may have additional information, including for example the winning bidder's name, seat assignment, mileage value account number, and the like. In this manner, miles are deducted from the passenger's account in accordance with their high bid. The creating of a debit record to debit miles from the customer's account, and the association of the debit record with the mileage value account may occur using point-of-sale device 150, computer system 160, and/or system 110 in alternative embodiments.

In some embodiments, the auction occurs prior to departure. For example, an airline may “auction” an upgraded, unused seat during the pre-boarding phase. In this example, bids may be verbally offered by passengers desiring to bid on the seat, may be offered in writing, or the like. In this embodiment, the winning bidder is aware of their win prior to boarding the airplane, train, or the like. The debit record may be created using, for example, computer system 160 and associated to the winning bidder's mileage value account. The mileage value account is, in one embodiment, identified using the winning bidder's presentation instrument, boarding pass, credit card, or the like.

In another embodiment, the auction is initiated prior to departure, but the winning bidder is notified “in flight” or during travel at which point they switch seats to the more desired seating section. In several other embodiments, the airplane, train, or the like is in travel when the entire auction is conducted. For example, an upgraded seat, or other good or service, may be offered using a public address system maintained on the airplane, train, or the like. The bids may be verbally offered by the customers and, in one embodiment, entered into point-of-sale device 150 by the flight attendant. The customers are then notified of the winning bid, at which time the winning bidder receives the seat upgrade, or other good or service. In this manner, the auction is treated as a silent auction, with each passenger given an opportunity to declare how many miles they wish to cash in for the desired good or service. A debit record is created with point-of-sale device 150, and transferred to computer system 160 and/or system 110 at a later time.

In still another embodiment, the auction is an open auction in which the flight attendant literally acts as an auctioneer to auction off the seat upgrade, or the like. The passengers may identify their bids through verbal bidding, use of the flight attendant call button, and the like. While the examples herein describe auctioning off a seat upgrade, the auction process may be used for other goods or services including meals, beverages, movies and the like. The auction also may involve other goods or services that traveling passengers may desire, such as pillows, blindfolds, earplugs and the like. Still further, some goods offered for purchase in an in-flight catalog may be maintained on the airplane. In this manner, the flight attendants can auction these goods to the customers for miles, and the customers can take immediate receipt of the auctioned item.

The invention has now been described in detail. However, it will be appreciated that the invention may be carried out in ways other than those illustrated in the aforesaid discussion, and that certain changes and modifications which may be practiced within the scope of the appended claims. Accordingly, the scope of this invention is not to be limited by those specific examples, but rather is to be accorded the full scope represented in the following claims.

What is claimed is:

1. A method for managing mileage value accounts, the method comprising:
receiving a presentation instrument having an account identifier stored thereon;
transmitting, from a point-of-sale device to a host computer system, the account identifier and a purchase item identifier;
identifying, using the host computer system, a customer account based on the account identifier;
associating a mileage value to the purchase item identifier; and
debiting the customer account by the mileage value associated to the purchase item identifier.

2. The method as in claim 1 wherein the presentation instrument is a boarding pass.

3. The method as in claim 2 wherein the account identifier is stored on the boarding pass using a magnetic stripe.

4. The method as in claim 1 wherein the account identifier comprises a frequent flyer account number.

5. The method as in claim 1 wherein the account identifier comprises a credit card number.

6. The method as in claim 1 wherein the purchase item identifier identifies an item to be purchased by a customer associated with the customer account, the item selected from a group of items comprising a meal, a beverage, and a movie.

7. The method as in claim 1 wherein the purchase item identifier identifies an item to be purchased by a customer associated with the customer account, the item selected from a plurality of items in a catalog.

8. The method as in claim 1 further comprising providing a confirmation to a customer associated with the customer account.

9. The method as in claim 8 further comprising printing a receipt with the confirmation.

10. The method as in claim 9 further comprising printing the receipt at the point-of-sale device after reading the account identifier from the presentation instrument.

11. A method for processing transactions using mileage value accounts, the method comprising:
receiving with a point-of-sale device a mileage summary for a plurality of customers;
receiving a presentation instrument from a first customer of the plurality of customers, the presentation instrument having an account identifier stored thereon;
receiving a purchase request from the first customer;
identifying a mileage value associated with a subject of the purchase request;
comparing the mileage value with the mileage summary for the first customer using the point-of-sale device; and
providing the first customer with the subject of the purchase request if the mileage value is less than or equal to an available mileage in the mileage summary for the first customer.

12. The method as in claim 11 further comprising creating a debit record associated with the purchase request and transmitting the debit record to a host computer system.

13. The method as in claim 12 wherein the debit record comprises the account identifier and the mileage value associated with the subject of the purchase request.

14. The method as in claim 11 wherein the presentation instrument is a boarding pass.

15. The method as in claim 11 wherein identifying the mileage value further comprises identifying the mileage value associated with both the subject of the purchase request and the account identifier.

16. The method as in claim 11 wherein the mileage summary comprises a list of available miles for at least some of the customers in the plurality of customers having mileage value accounts.

17. A computerized mileage value account system, comprising:
a plurality of presentation instruments that each have a unique account identifier;
a host computer system having a processor coupled to a database, and wherein the host computer system is configured to:
receive an account identifier and a purchase item identifier;
identify a customer account based on the account identifier;
associate a mileage value to the purchase item identifier; and
debit the customer account by the mileage value associated to the purchase item identifier.

18. The system as in claim 17 wherein the host computer system is further configured to receive the account identifier and the purchase item identifier from a point-of-sale device, and to return an authorization to the point of service device if an account associated with the account identifier has a mileage level greater than or equal to the mileage value associated with the purchase item identifier.

19. The system as in claim 17 wherein the host computer system database has stored therein a record of the account identifiers.

20. The system as in claim 17 wherein the host computer system database comprises a plurality of purchase item identifiers and a plurality of mileage values associated therewith.

21. The system as in claim 17 wherein the host computer system is coupled to a second database having a record of the account identifiers stored therein.

22. The system as in claim 21 wherein the second database is coupled to an airline host computer system.

23. The system as in claim 22 wherein the second database further comprises a plurality of purchase item identifiers and a plurality of mileage values associated therewith.

24. A method for processing transactions using mileage value accounts, the method comprising:
offering a good or a service to a plurality of customers;
receiving a bid from at least one of the plurality of customers for the offered good or service, the bid comprising a mileage amount;
comparing received bids from the plurality of customers, and selecting a winning bidder from the plurality of customers;
providing the good or the service to the winning bidder;
creating a debit record comprising the mileage amount of the winning bidder; and
associating the debit record with a mileage account of the winning bidder.

25. The method as in claim 24 wherein creating the debit record comprises creating the debit record using a point-of-sale device.

26. The method as in claim 24 further comprising comparing the received bid from the at least one customer with a mileage summary associated with the at least one customer to confirm the mileage summary is equal to or greater than the received bid.

27. The method as in claim 24 further comprising transmitting the debit record to a computer system, the computer system adapted to update the mileage account of the winning bidder.
